(19) United States
(12) Patent Application Publication
(10) Pub. No.: US 2014/0263707 A1
(43) Pub. Date: Sep. 18, 2014

(54) Pressure Dependent Variable Shape Nozzle Assembly

(71) Applicant: GENERAC POWER SYSTEMS, INC., Waukesha, WI (US)

(72) Inventors: Blake Zernicke, Janesville, WI (US); Mir Khan, Kenosha, WI (US); Greg Wischstadt, Wales, WI (US); David Serdynski, Waukesha, WI (US)

(73) Assignee: Generac Power Systems, Inc., Waukesha, WI (US)

(21) Appl. No.: 13/828,715

(22) Filed: Mar. 14, 2013

(51) Int. Cl. B05B 1/30

(52) U.S. Cl. CPC B05B 1/3006
USPC 239/11; 239/452

(57) ABSTRACT

A nozzle assembly and method of forming an adjustable spray pattern nozzle assembly that is usable with pressure washing systems includes a first body and a second body that are positionally secured relative to one another. The first body includes a fixed shaped orifice that defines the exit of a fluid spray from the nozzle assembly. The second body is disposed upstream of the first body and includes a pressure dependent variable shape orifice. The second body is formed of a resilient material that allows flexure of the second body in response to pressure of the fluid flow. Flexure of the second body manipulates the shape of the variable shape orifice and thereby allows the nozzle assembly to provide various spray patterns without user manipulation of the nozzle assembly.

### FIELD OF THE INVENTION

The present invention relates generally to pressure washer systems, and in particular, to a variable spray pattern nozzle assembly usable with such devices.

### BACKGROUND OF THE INVENTION

Pressure washers generally include a motor or engine that is operatively connected to a water pump. A high pressure hose connects a wand to a discharge side of the water pump. The wand commonly includes a pistol grip or the like that includes a trigger whose actuation effects discharge of a high-pressure water stream from the nozzle. Both the simplicity of operation and effectiveness associated with using such devices has made pressure washers a staple for various residential and commercial cleaning and surface preparation tasks.

Understandably, many cleaning and surface preparation operations are best carried out with the use of extraneous cleaning or surface treatment agents and/or manipulation of the spray pattern associated with operation of the pressure washer. For instance, some surface cleaning or preparation activities are more easily performed with a more centralized or unitary stream of water whereas other cleaning or surface preparation operations can be best performed with a fan or cone spray stream wherein the water stream is aligned along an axis or emanates from the wand in more conical shape, respectively. To better effectuate the desired cleaning or surface preparation operations, many power washers are configured for use with interchangeable or replaceable nozzles that are each configured to removably cooperate with the discharge end of the wand. Such systems commonly require that a number of discrete nozzle assemblies be provided and maintained to generate the desired spray pattern. The size of such nozzle assemblies renders them susceptible to loss or misplacement thereby requiring that the user to replace lost or misplaced nozzles if the spray pattern associated with the nozzle is needed for a desired cleaning or treatment operation.

Recognizing such a shortcoming, others provide adjustable nozzle assemblies that can be constructed to cooperate with the discharge end of a wand. Such nozzle assemblies can be configured to removably cooperate with the wand in a tool-less manner or be configured to more rigidly cooperate with the wand such that one or more tools are required to manipulate cooperation of the nozzle assembly with the wand. Many such adjustable nozzle assemblies include a control or dial that is associated with the nozzle assembly. The control or dial is commonly configured to be rotatable about an axis that is perpendicular to or normal to the direction of the fluid flow. Other adjustable spray nozzle assemblies include a plurality of discrete nozzles that each have unique orifice shapes associated with the desired spray pattern and can be selectively aligned and/or isolated from the fluid flow through the wand. Such adjustable spray pattern nozzle assemblies can suffer from a number of drawbacks.

Such nozzle assemblies must commonly be provided with a number of seals that prevent water from being allowed to exit the nozzle assembly at the orifice of unused nozzles or along paths associated with interface of the control with the fluid path or a support portion of the nozzle assembly. Such nozzle assemblies must also commonly include fairly tight manufacturing tolerances between the parts of the nozzle assembly that are intended to be moveable and require the formation of various parts of materials that are capable of withstanding the operating conditions associated with use of the respective nozzle assembly. Another drawback to such systems is the location of the spray adjustment mechanism at the discharge end associated with use of the pressure washing system.

As is well appreciated, pressure washing systems commonly generate a high pressure fluid flow. Appropriate caution must be exercised with respect to the direction and duration associated with the pressurized fluid stream to avoid damaging unintended as well as intended surfaces. Commonly, operation of a pressure washer for any activity at alternate spray patterns is desired at different times during use of the pressure washer and the activity undertaken. For instance, although a fan or cone pattern may be desired for general or light cleaning activities, the situation commonly arises that a more linear stream would be desired for spot treatment during the more general cleaning operation. Although commonly instructed against doing so, many users manipulate adjustable nozzle assemblies during operation of the underlying pressure washer device. Many users prefer to manipulate the adjustable nozzle assembly without suspending operation of the underlying device to avoid the interruption associated with restarting the device. Such action positions at least one of the user's hands in undesirable close proximity to the discharge end of the wand. Contrary to instructions to suspend and depressurize the operating systems of the pressure washer during interaction with the nozzle assembly, some users still tend to ignore such instructions.

Therefore, there is a need for a nozzle assembly that is convenient to manufacture and use and is operable with an underlying pressure or power washer system to provide alternate spray patterns. There is a further need for a nozzle assembly that can provide the alternate spray patterns without user interaction with the nozzle assembly.

### SUMMARY OF THE INVENTION

The present invention provides a nozzle assembly and method of forming an adjustable spray pattern nozzle for use with pressure washing systems that overcomes one or more of the drawbacks mentioned above. A nozzle assembly according to one aspect of the invention discloses an adjustable spray pattern nozzle assembly that includes a first body and a second body that are positionally secured relative to one another. The first body includes a fixed shaped orifice that defines the exit of a fluid spray from the nozzle assembly. The second body is disposed upstream of the first body and includes a pressure dependent variable shape orifice. The second body is formed of a resilient material that allows flexure of the second body in response to a pressure differential on opposite sides of the second body associated with the fluid flow therethrough. Flexure of the second body manipulates the shape of the variable shape orifice and thereby allows the nozzle assembly to provide various spray patterns without user manipulation of the nozzle assembly.

Another aspect of the invention that is usable with one or more of the above aspects discloses a pressure washer nozzle assembly that cooperates with a wand having a trigger and being configured to communicate a fluid flow to a discharge end of the wand. The nozzle assembly includes a first body having a fixed shape orifice connected to the wand such that the fluid flow is directed to atmosphere upon exit from the fixed shape orifice. A second body is disposed between the first body and the wand. The second body is formed of a non-rigid material and defines a variable shape orifice whose shape is manipulated by flexure of the second body caused by the fluid flow. The nozzle assembly allows the user to manipulate the spray pattern without manipulating the nozzle assembly.

Another aspect of the present invention that is usable with one or more of the above aspects discloses a nozzle assembly having a first orifice body and a second orifice body that is positioned proximate the first orifice body. The first orifice body includes a fixed shape discharge opening that provides egress of the fluid flow from the nozzle assembly. An opening is formed in the second orifice body. The opening of the second orifice body is aligned with the fixed shape discharge opening associated with the first orifice body. The second orifice body flexes in response to pressure associated with the fluid flow through the nozzle assembly. Flexure of the second orifice body manipulates a shape of the opening formed in the second orifice body. A change in the shape of the opening associated with the second orifice body manipulates a spray pattern delivered by the nozzle assembly. Such a nozzle assembly requires no user interaction with the nozzle assembly during use of the underlying pressure washing system to provide different spray patterns.

Another aspect of the invention that is usable with one or more of the above aspects discloses a method of forming an adjustable spray pattern nozzle assembly. The method includes providing a fixed shape discharge orifice and disposing a variable shape orifice upstream of the fixed shape discharge orifice such that a shape of the variable shape orifice is manipulated by a pressure associated with a fluid flow through the variable shape orifice and the fixed shape discharge orifice. Such a method provides a nozzle assembly that can be configured to automatically provide variable spray patterns.

Other aspects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

The drawings illustrate the best mode presently contemplated of carrying out the invention.

In the drawings:

FIG. 1 is a perspective view of a portable engine powered pressure washing device equipped with a variable spray pattern nozzle assembly according to the present invention;

FIG. 2 is a detailed perspective view of the nozzle assembly shown in FIG. 1;

FIG. 3 is an exploded view of the nozzle assembly shown in FIG. 2 and removed from the wand; and

FIG. 4 is a cross-sectional view of the assembled nozzle assembly shown in FIG. 2 and taken along longitudinal centerline 4-4 of the assembly.

### DETAILED DESCRIPTION OF THE DRAWINGS

FIG. 1 shows a nozzle or nozzle assembly 38 according to the present invention connected to a portable engine powered pressure washer 40. As shown in FIG. 1, pressure washer 40 includes an internal combustion engine 42 that is operationally connected to a pump 44. It is appreciated that the nozzle assembly 38 according to the present invention is usable with many underlying power or pressure washer systems, including those having an engine or a motor driven pump as well as less portable pressure washing systems. Those skilled in the art will readily appreciate the various alternative configurations of a power washing system usable with nozzle assembly 38 according to the present application.

With respect to pressure washer 40, engine 42 can be directly or indirectly (via a power transmission system such as a belt or other flexible drive member) coupled to pump 44. When engine 42 directly cooperates with pump 44 without supplemental power transmission systems, pump 44 can be considered a direct drive pump. It is appreciated that there a number of methodologies associated with generating a desired fluid pressure output associated with use of pressure washer 40. One methodology includes providing a pressure output of the pump that is a function of the operational revolutions per minute (rpm) of the pump and which is directly correlated to the operating speed or revolutions per minute (rpm) of the engine crankshaft. The higher the rpm of the pump, the higher the pump output pressure—assuming other system variables to be constant. In such a confirmation, the input rpm of the pump is controlled by the engine rpm by means of controlling the engine throttle such that, variable pressures can be provided at the pump output pressure via manipulation of the engine throttle or engine speed. Alternatively, it is appreciated that the pressure output of pump 44 may be manipulated by a regulator as disclosed below. The variable pressure pump output in conjunction with an engine speed or pump pressure selector dial allows one pressure washer to act as though it were capable of providing several different fixed operating pressures.

As alluded to above, another methodology for manipulating the pump discharge pressure delivered to the wand includes providing a variable setting regulator or bypass valve assembly associated with operation of the pump. Such a configuration includes a valve assembly that is integral to the pump or disposed between pump 44 and a wand 46 for communicating the pressurized fluid flow to wand 46 connected to pump 44. As explained further below, the valve assembly provides a control or regulator associated with regulating the pressure flow communicated to the wand in a manner partially independent of engine operating speed. That is, such a regulator allows the delivery of fluid to wand 46 at variable pressures at or below a maximum output pressure associated with the available water source pressure and given operating conditions of engine 42.

Still referring to FIG. 1, wand 46 is connected to an output side of pump 44 via a hose 48. A trigger 50 is supported by wand 46 and is located at one end of wand 46. Nozzle assembly 38 is connected to a discharge end 52 of wand 46. Pressure washer 40 preferably includes a chassis 54 having one or more wheels 56 and a handle 60 for improving the mobility of the unit to facilitate convenient transportation of pressure washer 40. It is appreciated that nozzle assembly 38 is usable with other less mobile pressure washing systems.

Discharge end 52 of wand 46 is commonly associated with an end of wand 46 that is opposite trigger 50. Discharge end 52 of wand 46 is constructed to removably cooperate with nozzle assembly 38 such that alternate or replacement nozzles or nozzle assemblies can be engaged with the wand. Preferably, such replacement nozzle assemblies can be configured to provide spray patterns and/or soaping and/or foaming functions associated with alternate uses of pressure washer 40. As explained further below, nozzle assembly 38 is configured to provide various spray patterns but it is appreciated that pressure washer 40 may have an operating range that extends beyond a range of operation associated with use of nozzle assembly 38. It is appreciated that nozzle assembly 38 can be configured to cooperate with wand 46 in a tool-less manner or in a manner that would require one or more tools to effectuate separation of nozzle assembly 38 from wand 46 for alternate uses of pressure washer 40 or use of pressure washer 40 with nozzles or nozzle assemblies having other functionality.

Pressure washer 40 can include a panel, bezel, or dashboard 61 that can include one or more instructional indicia 64 associated with the desired operation or intended use of pressure washer 40. Preferably, dashboard 61 includes one or more indicia that explain, either textually or pictographically, proper operation of pressure washer 40. It is also appreciated that dashboard 61 can include one or more receptacles or mounting portions 66 associated with supporting replaceable or interchangeable tips, nozzles, or nozzle assemblies 72, 74, 76, 78, 80 associated with alternate uses of pressure washer 40 beyond the operating capabilities of nozzle assembly 38. Preferably, aside from foaming operations, nozzle assembly 38 is configured to provide alternate spray patterns across the range of operation of pressure washer 40. As alluded to above, nozzles 72-80 are configured to interchangeably cooperate with discharge end 52 of wand 46 so as to replace nozzle assembly 38 thereby allowing use of pressure washer 40 for other uses, such as soap, foaming, cleaning, or treatment agent application operations.

As explained further below, it is also appreciated that one more of nozzles 72, 74, 76, 78, 80 could have a construction similar to—but preferably different than—nozzle assembly 38. It is envisioned that such a nozzle assembly and/or the providing of more than one nozzle assembly capable of generating various spray patterns would provide a pressure washer system with nozzles capable of providing an adjustable spray patterns but with a different range of spray pattern adjustment than nozzle assembly 38. Such a provision would provide a pressure washing system capable of providing a greater range of adjustment of the spray pattern as a function of an association of the range of adjustment of the nozzle assembly as it relates to a range of operation of the underlying pressure washer device.

It is further appreciated that wand 46 or pressure washer 40 can include a treatment agent introduction system 103 for introducing a cleaning or treatment agent to the fluid flow delivered to wand 46 via hose 48. It is appreciated that agent introduction system 103 could be configured to introduce such a treatment agent to the feed water stream at a low pressure or a high pressure side of pump 44, prior to delivery of the operating fluid to wand 46, immediately prior to the introduction of the operating fluid stream to nozzle assembly 38 at discharge end 52 of wand 46, and/or downstream of nozzle assembly 38. It is further appreciated that although agent introduction system 103 is shown as being supported proximate engine 42 and pump 44 associated with chassis 54, agent introduction system 103 could be associated with hose 48 and/or supported and/or integrated with wand 46. Regardless of the specific location of agent introduction system 103, each such configuration further increases the functionality of pressure washer 40 whether utilized with nozzle assembly 38 or another nozzle assembly 72-80.

FIG. 2 is a detailed perspective view of nozzle assembly 38 engaged with discharge end 52 of wand 46. A collar 84 is disposed at discharge end 52 of wand 46. Collar 84 preferably slidably cooperates with a fitting 86 that is secured to discharge end 52 of wand 46. Fitting 86 includes an outer radial surface 88 that is constructed to cooperate with a tool and/or be gripped by a user to facilitate rotation of fitting 86 relative to discharge end 52 of wand 46. Collar 84 is slidable and/or rotatable relative to fitting 86 about a longitudinal axis associated with wand 46 and facilitates a tool-less severable and sealable connection between nozzle assembly 38 and discharge end 52 of wand 46. Collar 84 is preferably biased to an orientation wherein collar 84 and fitting 86 securely and sealingly cooperate with nozzle assembly 38 so as to provide a secure and sealed connection of nozzle assembly 38 to wand 46. Regardless of the method of cooperation or operation of collar 84, the tool-less interaction between nozzle assembly 38 and wand 46, and similar such tool-less interactions, are commonly referred to as a quick-connect connections as such connections can commonly be effectuated manually without the use of supplemental tools. It is appreciated that the cooperation between collar 84, fitting 86, and nozzle assembly 38 is merely exemplary of one such configuration usable with the present invention.

Referring to FIGS. 2 and 3, nozzle assembly 38 includes a first body or first orifice body 90, a second body or second orifice body 92, a plurality of removable connectors or fasteners 94, and an optional base 96. First orifice body 90 includes an outer surface 98 that extends along a longitudinal axis between a first end 102 and a second or discharge end 104 of first orifice body 90. A fixed shape discharge opening or fixed shape orifice 106 extends through first orifice body 90 along axis 100. Axis 100 is generally aligned with and defines a longitudinal centerline associated with nozzle assembly 38 and the fluid flow therethrough.

Fixed shape orifice 106 provides egress for the fluid flow directed through nozzle assembly 38 to atmosphere 108. First orifice body 90 includes a number of passages or openings 110 that are each configured to slidably cooperate with a shaft portion 112 of a respective connector or fastener 94. Fastener openings 110 are radially offset from axis 100 associated with fixed shape orifice 106 of first orifice body 90. Fastener openings 110 are preferably circumferentially placed around fixed shape orifice 106. Although four fastener openings 110 are shown, it is appreciated that other numbers of fasteners and/or fastener openings, or other connection methodologies can be utilized as disclosed below.

Second orifice body 92 includes an outer perimeter 114 that extends along axis 100 between a first end 116 and a second end 118 of second orifice body 92. A variable shape opening or variable shape orifice 120 extends through second orifice body 92 along axis 100. A number of passages or fastener openings 122 extend through second orifice body 92 along respective axis that are aligned with, but offset from, axis 100 associated with variable shape orifice 120 and fixed shape orifice 106. Preferably, fastener openings 122 are radially offset from variable shape orifice 120 and spaced about second orifice body 92 at locations that are between an outer radial edge 124 of variable shape orifice 120 and outer perimeter 114 of second orifice body 92.

Optional base 96 includes a first portion 128 and the second portion 130 that can smoothly transition from one another as they extend between a first end 132 and a second end 134 of optional base 96. Alternatively, a step or ridge may define a transition between first portion 128 and second portion 130 of optional base 96. A recess, channel, or groove 136 is formed in first portion 128 of base 96 proximate first end 132. A recess, groove, or channel 138 that is offset from groove 136 and first end 132 of base 96 is formed in first portion 128 of base 96. A land 140 extends in a generally continuous curvilinear manner about a circumference of first portion 128 between groove 136 and channel 138 in a direction along axis 100. Preferably, groove 136, channel 138, and land 140 extend about the entire circumference of first portion 128 of base 96.

Groove 136 is shaped to cooperate with a seal associated with the interior of fitting 86 and channel 138 is shaped to removably cooperate with a retainer whose orientation is affected by the orientation of collar 84 relative to fitting 86. When the retainer is engaged with channel 138, groove 136 seats against the seal associated with fitting 86 so as to provide a sealed interaction along the fluid path, indicated by arrow 144, between wand 46 and optional base 96. Translation of collar 84 relative to fitting 86 allows the retainer to disengage channel 138 such that optional base 96, and the first and second orifice bodies 90, 92 associated with nozzle assembly 38 supported thereby, can be removed from fitting 86 thereby removing nozzle assembly 38 from wand 46. Preferably, sufficient space is provided between first portion 128 and second portion 130 of base 96 along axis 100 such that second portion 130 of optional base 96 does not interfere with user interaction and/or manipulation of collar 84 relative to fitting 86.

Second portion 130 of optional base 96 includes a number of threaded cavities 148 that are radially offset from a discharge opening 150 of optional base 96. Cavities 148 are also preferably fluidly isolated from fluid path 144. Cavities 148 are spaced about second end 134 of optional base 96 between an outer perimeter surface 152 of second portion 130 and an outer circumferential edge 154 of discharge opening 150.

Each of fasteners 94 preferably includes a head portion 156 that is larger than the corresponding shaft portion 112 of the respective fastener 94. Shaft portions 112 of fasteners 94 have a diameter that allows the respective shaft portion 112 to pass through respective fastener openings 110 associated with first orifice body 90, respective fastener openings 122 associated with second orifice body 92, so as to threadably engage a respective cavity 148 associated with optional base 96. Head portions 156 of respective fasteners 94 seat against discharge end 104 of first orifice body 90, or can be received in a counter bore, such that second orifice body 92 is captured between optional base 96 and first orifice body 90. When fully assembled, nozzle assembly 38 provides a mechanically secure and fluidly sealed interaction between first orifice body 90, second orifice body 92, and base 96 and/or wand 46 as explained below.

It is appreciated that other connection methodologies are envisioned. That is, discharge end 52 associated with wand 46 could be configured to directly cooperate with fasteners 94 and/or another securing methodology to provide a sealed and mechanically sound connection of first orifice body 90 and second orifice body 92 directly to wand 46. Understandably, such a configuration omits the quick-connect functionality associated with optional base 96 and the removable interaction with collar 84 and fitting 86. Further, although four fasteners are shown as securing first orifice body 90 and second orifice body 92 relative to optional base 96, is as appreciated that other numbers of connectors or fasteners could be provided and/or other connection methodologies could be utilized in associating first and second orifice bodies 90, 92 relative to one another and wand 46. It is appreciated that countless such alternatives exist for securing first body 90 relative to second orifice body 92, and the fluid path associated with wand 46.

For instance, discharge end 52 of wand 46 may include a threaded configuration configured to cooperate with a threading formed on a radially interior or exterior surface of first orifice body 90 such that second orifice body 92 may be captured between first orifice body 90 and discharge end 52 of wand 46. Alternatively, first orifice body 90 may be configured to be secured directly to second orifice body 92 which may in turn be configured to be secured directly to a base 96 and/or discharge end 52 of wand 46. Understandably, such configurations are merely exemplary of alternatives for providing a mechanically sound and fluidly sealed interaction between first orifice body 90, second orifice body 92, and wand 46.

Referring now to FIGS. 1 and 4, upon actuation of trigger 50 during operation of pressure washer 40, fluid flow 144 is directed downstream through wand 46 and directed through optional base 96 and first and second orifice bodies 90 and 92, respectively, prior to being introduced to atmosphere 108 via the fixed shape orifice 106 defined by first orifice body 90. First orifice body 90 and optional base 96 or wand 46, depending on the connection methodology as disclosed above, define chambers, gaps, or cavities 158, 160, respectively, that are disposed on opposite sides of second orifice body 92 along axis 144 and proximate variable shape orifice 120. A portion or overhanging portion 162 of second orifice body 92 that is proximate variable shape orifice 120 overhangs an adjacent radially interior surface 164 of first orifice body 90 and an adjacent radially interior surface 166 of optional base 96 or wand 46.

First orifice body 90 is preferably thicker in a dimension aligned with axis 100 then second orifice body 92. Alternatively, or in combination with the dimensional association, second orifice body 92 can be formed of a more flexible, deformable, or pliable material than first orifice body 90. Preferably, second orifice body 92 is formed of a dimension and/or a material to tolerate manipulation of the shape of variable shape orifice 120 in response to the fluid flow through nozzle assembly 38 whereas a shape of fixed shape orifice 106 does not deviate in response to fluid flow therethrough. However, variable shape orifice 120 and fixed shape orifice 106 complement one another such that changes to the shape of variable shape orifice 120 manipulate the shape of the spray pattern directed to atmosphere through fixed shape orifice 106. Preferably, variable shape orifice 120 can achieve shaped that allow delivery of a generally linear fluid flow spray pattern, variable fan shape fluid spray patterns, and/or variable cone shape fluid flow spray patterns. As alluded to above and explained further below, it is appreciated that various nozzles assemblies can be provided that each provide different ranges of adjustment of the fluid flow spray across a range of operation of the underlying pressure washer 40.

Regardless of the dimensional or material deviations between first orifice body 90 and second orifice body 92, variable shape orifice 120 of second orifice body 92 is configured to be manipulated by the pressures associated with fluid flow 144 and the spatial accommodations provided by first cavity 158 and second cavity 160. Second orifice body 92 is resiliently deformable from an at rest position, associated with lower operating pressures, to a fully deformed position, wherein the shape of orifice 120 is manipulated by the passage of fluid flow 144 through the variable shape orifice 120 at a maximum operating pressure of either the underlying pressure washer 40 or a maximum deflection of second orifice body 92.

It is appreciated that the at rest shape associated with variable shape orifice 120, as well as the spatial association between an overhanging portion 162 of second orifice body 92 relative to first orifice body 90 and optional base 96 or wand 46, can be manipulated to achieve a desired range of spray patterns across the operating range associated with fluid flow 144. It is further appreciated that the shape and/or material associated with first orifice body 90 and/or fixed shape orifice 106, second orifice body 92 and/or an at rest or degree of deviation associated with variable shape orifice 120, and/or the spatial accommodations associated with cavities 158, 160 can be manipulated to provide various alternate spray patterns associated with a desired range of operation associated with nozzle assembly 38 and/or pressure washer 40. Preferably, each of first orifice body 90 and second orifice body 92 are constructed of materials and dimensions sized to withstand the operating parameters of pressure washer 40 to which the nozzle assembly is engaged.

Although shown in FIG. 4 that first orifice body 90 and second orifice body 92 have having generally matching outer perimeter footprints, it is appreciated that the exterior contour associated with first orifice body 90, second orifice body 92, and/or optional base 96 or discharge end 52 of wand 46 could be provided in virtually any shape that facilitates a secure and sealed connection along fluid path 144 relative to first orifice body 90, second orifice body 92, and the pressurized fluid stream delivery device—i.e. wand 46 but includes the material or dimensional tolerances associated with facilitating changes in the shape of the variable shape orifice 120, and thereby changes to the spray pattern, associated with operation of pressure washer 40.

Regardless of the range of motion of the overhanging portion 162 of second orifice body 82 and the range of change of the shape of variable shape orifice 120, nozzle assembly 38 provides a nozzle assembly that can provide multiple spray patterns and does so in a manner that requires no user interaction with the nozzle assembly. Although it is envisioned that nozzle assembly 38 can be serviceable, manipulation of the spray pattern can be effectuated by user interaction or partial activation of the trigger and/or by user interaction with the control of the underlying pressure washer 40 rather than interaction with the discharge end 52 associated with wand 46 and/or nozzle assembly 38.

Many changes and modifications could be made to the invention without departing from the spirit thereof. The scope of these changes will become apparent from the appended claims.

1. A pressure washer nozzle assembly comprising:
a wand having a trigger and being configured to communicate a fluid flow to a discharge end of the wand;
a first body having a fixed shape orifice connected to the wand such that the fluid flow is directed to atmosphere upon exit from the fixed shape orifice; and
a second body disposed between the first body and the wand, the second body having a variable shape orifice and being formed of a non-rigid material such that a shape of the variable shape orifice can be manipulated by flexure of the second body caused by the fluid flow.

2. The pressure washer nozzle assembly of claim 1 wherein an axis of the fixed shape orifice is aligned with an axis of the variable shape orifice.

3. The pressure washer nozzle assembly of claim 1 wherein the first body includes a cavity that is larger than the fixed shape orifice and disposed between the fixed shape orifice and the second body relative to a direction of the fluid flow.

4. The pressure washer nozzle assembly of claim 3 wherein the cavity is shaped to accommodate flexure of the second body.

5. The pressure washer nozzle assembly of claim 1 wherein the first body and the second body each include at least one opening that extends along an axis that is aligned with and offset from an axis of the fixed shape orifice and the variable shape orifice.

6. The pressure washer nozzle assembly of claim 5 further comprising at least one fastener that is constructed to cooperate with the at least one opening to secure the first body at an orientation that overlies the second body.

7. The pressure washer nozzle assembly of claim 6 wherein the at least one opening of each of the first body and the second body is further defined as a plurality of openings that are oriented radially about the respective one of the first body and the second body and the assembly includes a plurality of fasteners that are constructed to cooperate with a set of the respective openings.

8. A nozzle assembly comprising:
a first orifice body having a fixed shape discharge opening;
a second orifice body positioned proximate the first orifice body, the second orifice body having an opening formed therein which is aligned with the fixed shape discharge opening; and
wherein the second orifice body is flexible in response to pressure associated with a fluid flow through the first orifice body and the second orifice body to manipulate a shape of the opening formed in the second orifice body.

9. The nozzle assembly of claim 8 wherein the first orifice body and the second orifice body each further include a passage that is radially offset from the opening and the fixed shape discharge opening, respectively.

10. The nozzle assembly of claim 9 further comprising a fastener constructed to cooperate with the passage of each of the first orifice body and the second orifice body to secure the first orifice body and the second orifice body to one of a base and a discharge end of a wand.

11. The nozzle assembly of claim 8 wherein the first orifice body and the second orifice body are formed of dissimilar materials.

12. The nozzle assembly of claim 8 wherein the first orifice body is thicker than the second orifice body relative to a direction aligned with an axis of the opening and the fixed shape discharge opening.

13. The nozzle assembly of claim 8 wherein the first orifice body and the second orifice body have matching outer perimeter foot prints.

14. The nozzle assembly of claim 8 further comprising at least one of another first orifice body and another second orifice body having a fluid opening that is a different size than a respective fixed shape discharge opening of the first orifice body or the opening of the second orifice body.

15. A method of forming an adjustable spray pattern nozzle assembly, the method comprising:
providing a fixed shape discharge orifice; and
disposing a variable shape orifice upstream of the fixed shape discharge orifice such that a shape of the variable shape orifice is manipulated by a pressure associated with a fluid flow through the variable shape orifice and the fixed shape discharge orifice.

16. The method of claim 15 further comprising removably connecting the fixed shape discharge orifice and the variable shape orifice to a wand connected to a pressure washer.

17. The method of claim 15 further comprising the variable shape orifice of a flexible material.

18. The method of claim 17 further comprising the variable shape orifice and the fixed shape discharge orifice of dissimilar materials.

19. The method of claim 17 further comprising forming a gap between a portion of the fixed shape discharge orifice and a portion of the variable shape orifice to allow flexure of the variable shape orifice.

20. The method of claim 15 further comprising providing at least one removable connector that secures the fixed shape discharge orifice relative to the variable shape orifice such that an opening of the fixed shape discharge orifice and an opening of the variable shape orifice are aligned with one another along a longitudinal centerline associated with the fluid flow.
